(19) United States
(12) Patent Application Publication
(10) Pub. No.: US 2006/0148423 A1
(43) Pub. Date: Jul. 6, 2006

(54) Systems for locating and identifying victims of manmade or natural disasters

(76) Inventor: Richard Sharpe, Woodbridge, IL (US)

Correspondence Address: LATHROP & GAGE LC, 4845 PEARL EAST CIRCLE, SUITE 300, BOULDER, CO, 80301, US

(21) Appl. No.: 11/325,944

(22) Filed: Jan. 5, 2006

Related U.S. Application Data
(60) Provisional application No. 60/641,744, filed on Jan. 5, 2005.

(51) Int. Cl. H04B 1/38; H04M 11/04; G01S 5/04; G08B 23/00

(52) U.S. Cl. 455/90.1; 340/573.1; 455/404.1; 342/443

(57) ABSTRACT

Systems for locating and identifying victims of manmade or natural disasters are disclosed. A system includes a transceiver having a transmitter for transmitting a first emergency location signal that contains a first digital identification and a receiver for receiving a second emergency location signal and decoding a second digital identification. In an embodiment, individual victims may be assigned to individual searchers according to their unique digital identification in order to expedite and organize rescue efforts. Additionally, or alternatively, digital identification may be used to differentiate between different types of signals, for example, an egress or a specific waypoint signal and a personal signal.

### RELATED APPLICATIONS

This application claims priority to U.S. Application No. 60/641,744, filed Jan. 5, 2005, which is incorporated herein by reference.

### BACKGROUND

A person can become buried in an accident such as an avalanche or collapsed building. If the person can move, he or she may try to summon rescuers by cell phone or by yelling. However, cell phones do not provide pinpoint location information, and yelling may exhaust a victim's energy and/or air supply. Other rescue methods, such as the use of specially trained dogs that locate buried victims, are also less than ideal because the time required to bring the dogs to an accident site can be longer than a victim is able to survive with limited air and/or traumatic injury.

Avalanche rescue beacons provide for expedited recovery of a buried victim. They are worn by many winter recreationalists, such as skiers, snowboarders, snowshoers and snowmobilers. Typically, a person traveling in or near avalanche terrain wears a rescue beacon that transmits at 457 kHz over a distance of 50-80 meters. The signal is transmitted for 100 milliseconds, then a pause ensues for 200 milliseconds. If a member of a party becomes buried in an avalanche, the remaining members switch their beacons from transmit to receive mode. The intensity of the radio signal received by a searcher, which may be converted in the transceiver to an audio and/or visual signal, generally becomes greater as a searcher moves closer to a victim. When the search area has been narrowed to approximately two square feet, the searcher begins probing the snow and/or digging to free the entrapped victim.

One such avalanche rescue beacon is disclosed in U.S. Pat. Nos. 6,167,249 and 6,484,021, both titled “Avalanche victim locating transceiving apparatus”. These patents describe an avalanche rescue beacon having a first antennae, a second antennae, and a third virtual antennae providing three-dimensional vector analysis of a victim's location. The rescue beacon is able to filter multiple transmission signals, which may be useful when more than one victim is buried, by ignoring signals that are more than±3-5 degrees from the middle of the flux pattern received by a transceiver.

U.S. Pat. No. 6,960,996, titled “Device for locating trapped victims and a method of operating such a device”, discloses another avalanche rescue transceiver. The disclosed device is able to differentiate between multiple transmission signals by monitoring transmission characteristics of a signal, such as subtle differences among individual transmitters in signal strength, transmission time and/or frequency that result from normal deviations from manufacturer's specifications. The device may automatically, or under user command, “lock on” to one signal to reduce confusion and allow for the rescue of one victim at a time.

The devices disclosed in the aforementioned patents, which are incorporated herein by reference, do not indicate which victim the rescuer will find. It is therefore possible that multiple searchers will waste time locating the same victim, while other victims remain buried. Prior art avalanche beacons are confusing because multiple signals look identical to the rescuer.

Aircraft are typically equipped with emergency locator transmitters, for identifying the location of downed aircraft. These transmitters operate at frequencies including one or more of the international emergency frequencies of 121.5 MHz, 243 MHz, or 406 MHz. Aircraft locator transmitters are known that digitally transmit an identity code associated with the specific locator transmitter. Aircraft locator transmitters are also known that transmit coordinates derived from integral global positioning satellite (GPS) receivers.

Aircraft locator transceivers are also known; however, receivers included in aircraft locator transceivers are typically intended for air-to-ground communications with survivors after an accident. Thus, aircraft locator transceivers do not incorporate circuitry for receiving, decoding, or displaying an identity code, or for determining a direction to a transmitting locator transmitter. These functions are typically provided in separate equipment located elsewhere, such as in satellites, fitted to search for aircraft, or in equipment that may be brought to the site after an accident.

Aircraft locator transmitters typically incorporate an inertia sensor intended to activate the transmitter when the transmitter is subjected to an abrupt deceleration such as may occur when an aircraft carrying the transmitter crashes.

### SUMMARY

In an embodiment, a transceiver for locating and identifying a victim of a manmade or natural disaster includes a transmitter for transmitting a first emergency location signal that contains a first digital identification; and a receiver for receiving a second emergency location signal and decoding a second digital identification.

In an embodiment, a method of performing a rescue in a hazardous environment includes placing a first locator transmitter at a first waypoint near an entrance of the hazardous environment, the first locator transmitter transmitting an emergency locator signal comprising digitally encoded identification; entering the hazardous environment to search for a victim; using a locator receiver to identify a bearing from the locator receiver to the first locator transmitter; and using the bearing from the locator receiver to the first locator transmitter to move towards the first waypoint.

In an embodiment, a method of rescuing a person trapped by a disaster includes attaching a first locator transmitter to the person; causing the first locator transmitter to transmit an emergency locator signal comprising digitally encoded identification; using a locator receiver to identify a bearing from the locator receiver to the first locator transmitter; and using the bearing from the locator receiver to the first locator transmitter to locate the person.

### BRIEF DESCRIPTION OF THE FIGURES

FIG. 1 shows one exemplary embodiment of a rescue transmitter.

FIG. 2 shows one exemplary embodiment of a rescue receiver for receiving signals from the rescue transmitter of FIG. 1.

FIG. 3 shows one exemplary embodiment of a rescue transceiver.

FIG. 4 shows one exemplary schematic of the rescue transmitter of FIG. 1.

FIG. 5 shows one exemplary schematic of the rescue receiver of FIG. 2.

### DETAILED DESCRIPTION OF THE FIGURES

As discussed in more detail below, a rescue transmitter transmits an emergency location signal (i.e., a radio signal) that includes an encoded digital identification. A rescue receiver receives the emergency location signal; it includes a digital identification decoder that decodes the digital identification within the emergency location signal. The rescue receiver and rescue transmitter together form a system for locating victims of manmade or natural disasters. In an embodiment, the emergency location signal is also capable of being received by receivers that do not include digital identification decoders; thus, the transmitter disclosed herein may be compatible with all receivers that detect an international emergency signal. In an embodiment, the international emergency signal has a frequency of 457 kilohertz.

The receiver may include a display that aids a rescuer in locating the transmitter unit; the transmitter may be carried by a person or incorporated into an inanimate object, such as an exit sign. When worn by a person, the rescue transmitter may be very small and compact such that it easily fits into a purse or pocket, for example. Alternatively, a rescue transmitter and/or a rescue receiver may be anchored to a person's body. For example, a unit may be strapped to a person's chest so that it is not easily torn from the person's body, or strapped to the back of a person's hand; e.g., a firefighter may raise their hand to their face to view the display under conditions of diminished visibility.

In one embodiment, a single unit includes functionality of both the rescue transmitter and the rescue receiver. This transceiver unit may then be used interchangeably as the rescue transmitter and the rescue receiver described herein.

The rescue transmitter/receiver/transceiver may have a compact housing that is water-proof or water-resistant. A rubberized coating may be applied to the unit to improve its shock resistance. The unit may be able to withstand temperatures between about −20-300 degrees Fahrenheit.

The rescue transmitter may operate to transmit the emergency location signal without the digital identification. Similarly, the rescue receiver may operate to receive the emergency location signal without the digital identification. If the emergency location signal includes the digital identification, the rescue receiver may operate to discern between two or more emergency location signals, and may thereby facilitate selective locating of the emergency location signal with a specified digital identification. Further, by discerning between the emergency location signals, the rescue receiver can avoid giving inaccurate bearings that may result when two signals interfere with each other.

In one embodiment, the digital identification is encoded within the emergency location signal using frequency shift keying (“FSK”). In another embodiment, the digital identification is encoded within the emergency location signal using carrier amplitude modulation. In yet another embodiment, two or more electromagnetic signals may be used to transmit the emergency location signal and a digital identification signal. For example, one signal is transmitted at the international emergency location signal frequency and a second signal is transmitted at a distinct frequency, where the second signal contains the digital identification. Other encoding schemes may be used without departing from the scope hereof.

The rescue receiver may, for example, include a digital data receiver module and may include one or more antennae to determine signal direction information. If two or more antennae are included, the rescue receiver may utilize three-dimensional vector analysis to determine direction and approximate distance from the rescue receiver to the source of the emergency location signal. If the emergency location signal includes digital identification, the rescue receiver may operate to selectively ignore unwanted emergency location signals to speed location of a desired emergency location signal source.

In an example of operation, a digital identification of a rescue transmitter associated with a critical victim may be selected on the rescue receiver to give the critical victim priority over other less-critical victims. In another example of operation, when multiple searchers are engaged in searching for multiple victims, several rescue receivers may be in use with each rescue receiver assigned to recognize and respond to an emergency location signal carrying a different digital identification (i.e., associated with a different victim), thereby expediting recovery of all victims.

The rescue receiver may include a proximity alarm that indicates when the rescue receiver is proximate to the source of a received emergency location signal. The proximity alarm may also indicate when the rescue receiver moves away from a rescue transmitter.

In an illustrative example of operation, a rescue transmitter is located in an exit sign marking an exit of a public building, and an egress emergency location signal having digital identification is transmitted by the rescue transmitter. A firefighter, hazardous material responder, or other person carrying a rescue receiver may be guided to the nearest exit, or to a particular digitally-selected exit, by the emergency location signal.

In another illustrative example of operation, a rescue transmitter is placed by a firefighter at an important waypoint in or near a hazardous environment, such as an exit of a burning building, and an emergency location signal having digital identification is transmitted by the rescue transmitter. The firefighter may place additional transmitters at additional important waypoints, such as hallway junctions, interior doorways, or stairwells. It is known that visibility within smoke-filled buildings can be extremely poor, so poor that waypoints can often not be visually identified from even a few yards away. The same, or another, firefighter carrying a rescue receiver may be guided to the nearest waypoint, or to a particular digitally-selected waypoint such as the exit, by the emergency location signal.

Should the same, or another, firefighter get into trouble or find victims requiring assistance from additional firefighters, while in the building, that firefighter may activate an additional rescue transmitter. In an embodiment, the additional rescue transmitter is incorporated into a rescue transceiver with the firefighter's rescue receiver. The additional firefighters may be guided to the first firefighter by an emergency location signal having digital identification and transmitted by the rescue transceiver. In this example, the additional firefighters may use the digital identification of the emergency location signals to distinguish between the location signal emitted by the firefighter's transceiver and those signals emitted by transmitters located at waypoints.

In an embodiment, the firefighter wears a turnout coat having a half-dozen spring clips attached to the chest. A rescue transmitter is held in each spring clip. Whenever the firefighter wishes to mark a waypoint, the firefighter removes a transmitter from a spring clip of the coat, and places it at the desired waypoint. As each transmitter is removed from the spring clip, it activates and begins sending an emergency locator signal with digital identifier. The firefighter also wears a rescue transceiver on the back of a wrist. In this embodiment, as each transmitter is removed from the spring clip and activates, the rescue transceiver records the digital identification of the transmitter in an ordered list of activation. The transceiver has a “step back” button. When the firefighter desires to retrace his path through multiple waypoints to an entrance waypoint, it automatically indicates direction to the last-activated transmitter. At each press of the step-back button, such as when the firefighter has retraced his path to a waypoint, the transceiver displays direction to the next most recently activated transmitter.

Similarly, the system may be used to locate skiers, workers or soldiers who become injured or disabled in a hazardous environment.

Although multiple embodiments disclosed herein are described with particular reference to firefighters or skiers, for example, it will understood that the systems and methods disclosed are not limited to specific applications or to use by a specific class of individuals. Any person may utilize the disclosed systems and methods to determine the relative direction and proximity of two or more objects and/or persons.

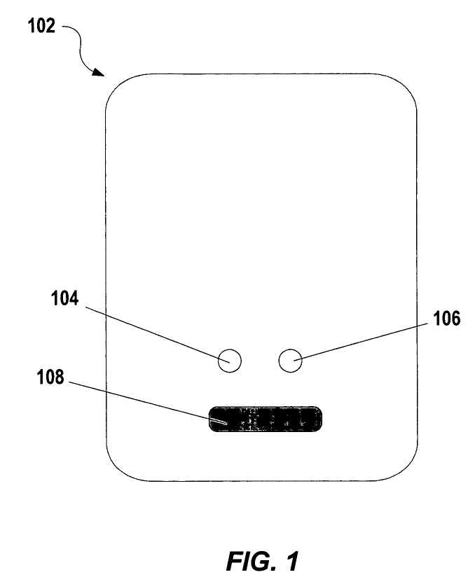

FIG. 1 shows one exemplary embodiment of a rescue transmitter 102. Rescue transmitter 102 is shown with a green light-emitting diode (“LED”) 104, a red LED 106 and an on/off button 108. LEDs 104, 106 may, for example, indicate mode of operation or system failure warnings. For example, flashing of both LEDs 104, 106 may indicate low battery power or self check failure; a green flashing LED 104 alone may indicate that rescue transmitter 102 is transmitting constantly; a red flashing LED 106 alone may indicate that rescue transmitter 102 is transmitting intermittently to preserve battery life.

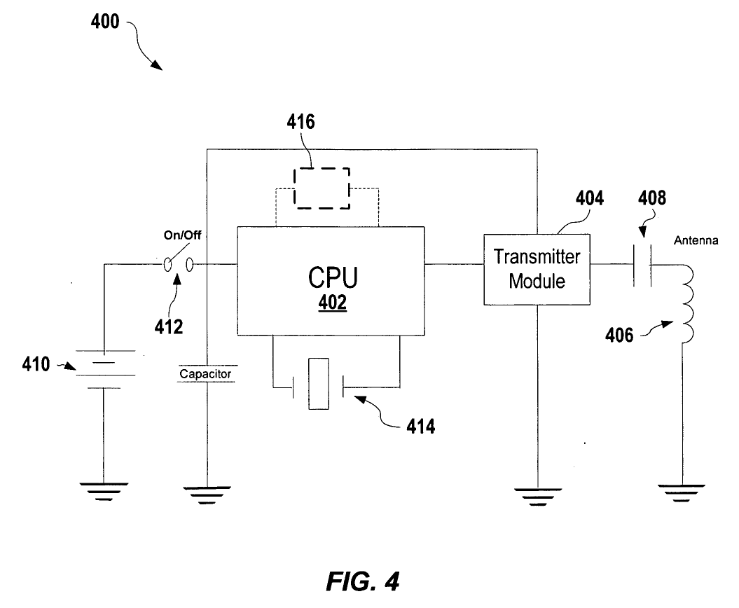

Rescue transmitter 102 may include a digital transmitter module (see, e.g., FIG. 4) that is programmed with a unique digital identification such that when activated by button 108, rescue transmitter 102 transmits an emergency location signal that includes encoded digital identification. The digital identification may be assigned based on an intended use of that particular transmitter type. For example, egress transmitters may be assigned digital IDs beginning with a particular pattern (e.g., a pattern read as “123XXX”, where the first three digits “123” indicate that the signal source is an egress transmitter). Similarly, transmitters intended to mark non-exit waypoints within a building may be assigned digital IDs beginning with a different pattern, such as “456XXX”, where the first 3 digits “456” indicate a waypoint transmitter. Likewise, personal transmitters may be assigned digital IDs beginning with the pattern “999XXX”, for example, where the first three digits “999” indicate that the source is a transmitter carried by a person. Egress transmitters may additionally, or alternatively, be differentiated from personal transmitters by using different transmission/pause sequences (e.g., egress transmitters may transmit for 100 ms and pause for 1.2 seconds).

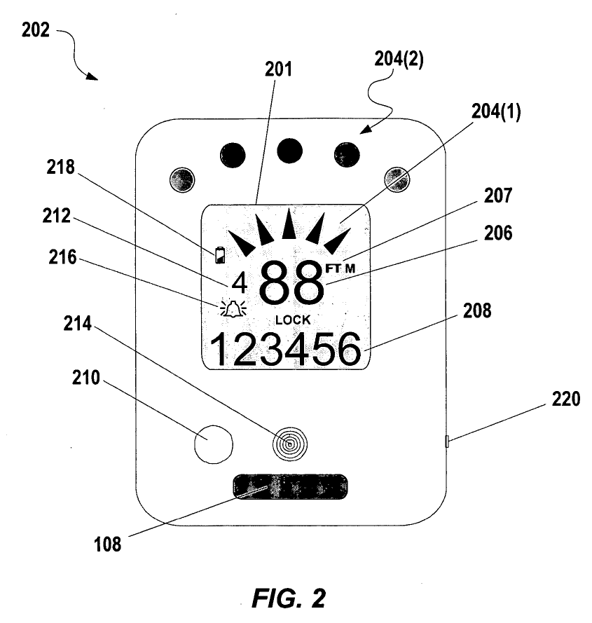

FIG. 2 shows one exemplary embodiment of a rescue receiver 202 that includes within a display 201: directional indicators 204, a distance indicator 206 and a digital identification indicator 208. Display 201 may, for example, be a backlit LCD and/or a group of LEDs. In one embodiment, display 201 includes an LCD display that tends to become unreadable when heated. In this embodiment, underlying LEDs illuminate to provide some information to a user when the LCD display is inoperative. Information shown on display 201 may be frozen at regular intervals (e.g., every 2-5 seconds) to provide proper directional and distance information.

Directional indicators 204 provide direction information relative to a source of an emergency location signal. For example, arrows 204(1) and/or LEDs 204(2) may indicate direction.

Distance indicator 206 may display distance between rescue receiver 202 and a source of the emergency location signal (e.g., rescue transmitter 102). Distance indicator 206 may display units in feet or meters 207.

Digital identification indicator 208 may, for example, display alphanumeric digital identifications of emergency location signals received by rescue receiver 202. In one example, if rescue receiver 202 simultaneously receives more than one emergency location signal with digital identification, digital identification indicator 208 may scroll through the alphanumeric representations of the received signals. A mode button 210 may, for example, select one or more displayed digital identifications for the receiver to identify and track. When the receiver is identifying and tracking a particular digital identification, the directional indicators 204 correspond to direction to the rescue transmitter that transmits that digital identification.

In one embodiment, mode button 210 may select exclusively waypoint or personal signals for detection. For example, when a firefighter has located a victim and needs to move to the nearest exit he may toggle from detecting personal signals to detecting waypoint signals using mode button 210. As the firefighter works his way back to a building entrance, the firefighter may switch from detecting a first waypoint, perhaps at a hallway junction, to another waypoint, perhaps located at the building exit, often in reverse of the order in which the firefighter placed the transmitters. A number of IDs indicator 212 may indicate the number of emergency location signals with and/or without digital identification currently received by rescue receiver 202. A battery level indicator 218 may graphically depict the amount of charge left in a battery used to power rescue receiver 202.

Digital identification of one or more rescue transmitters 102 may be manually entered into rescue receiver 202 using one or more input buttons, for example, to scroll through numbers and letters of the alphabet. Alternatively, digital identification of one or more rescue transmitters 102 may be entered into rescue receiver 202 by connecting it to a computer either directly, through an infrared link, or through a wireless link. For example, a party of skiers may associate alphanumeric digital identifications of their party members with the names of the party members. In the absence of such programming, receiver 202 may be configured to display an alphanumeric digital identification on indicator 208. In the case of an emergency, each searcher may be assigned to a particular victim by name (if programmed) or by alphanumeric digital identification.

Unique alphanumeric digital identifications may be programmed by a manufacturer. Alternatively, transmitter 102 may include input buttons that allow a user to choose their own digital identification.

Rescue receiver 202 may also have a proximity alarm that indicates (e.g., through proximity alarm icon 216 and/or speaker 214) whether rescue receiver 202 is proximate, or not, to an emergency location signal source (e.g., rescue transmitter 102). For example, an audio signal associated with proximity alarm 216 may become louder as a receiver is moved closer to a transmitter, and weaker as the receiver is moved further from the transmitter.

In an embodiment, a vibration mechanism is included in rescue receiver 202. The vibration mechanism is activated when direction indicator 204 is pointing within a few degrees of straight ahead, for example. An earphone jack 220 that accepts headphones may be included in rescue receiver 202 so that the signal received by rescue receiver 202 may be isolated from background noise and from signals received by other nearby rescue receivers.

In one example of operation, Alzheimer patients may each carry, or be fitted with (e.g., attached to a wrist or ankle), a rescue transmitter 102; a rescue receiver 202 may be located where these patients are to remain. When a patient exceeds a certain distance from rescue receiver 202 (e.g., the patient wanders away from the location of the rescue receiver 202), the proximity alarm of rescue receiver 202 is activated, thereby indicating that the patient has strayed. Similarly, children and/or pets may each carry or be fitted with a rescue transmitter 102 and a parent or guardian may carry a rescue receiver 202. The proximity alarm would thereby indicate when one or more child or pet strays further than a certain distance from the guardian. As appreciated, rescue transmitters 102 and rescue receivers 202 may be used for other applications where notification of change in proximity of two objects or people is desired.

In one embodiment, the proximity alarm may activate after a signal from rescue transmitter 102 is not detected for a certain period of time, thereby preventing false alarms, since radio signals may be intermittently blocked (e.g., by other radio signals or certain objects that pass between transmitter and receiver).

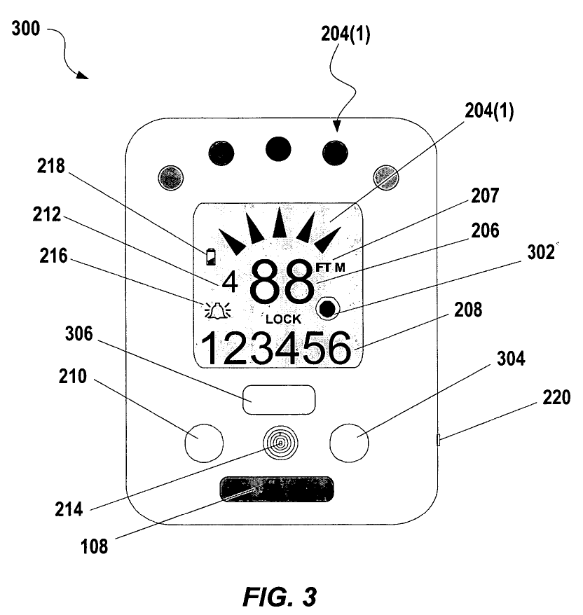

FIG. 3 shows a rescue transceiver 300. Transceiver 300 is able to transmit and receive signals. For example, transceiver 300 may be switched from transmit mode to receive mode when search button 304 is activated. Transmit mode icon 302 indicates when transceiver 300 is transmitting rather than receiving. Transceiver 300 may optionally include a panic button 306 that turns the transceiver to transmit mode. For example, panic button 306 may be activated when a searcher, whose transceiver is initially in the receive mode, becomes trapped or injured. Transceiver 300 may also include an automatic reset feature that switches a receiving transceiver to transmit mode after a given period of time, unless a user override is entered.

FIG. 4 shows one exemplary schematic 400 of transmitter 102 of FIG. 1. Schematic 400 shows a central processing unit (“CPU”) 402 that generates a signal which is modulated by a transmitter module 404. The modulated signal is fed to an antennae 406 via a capacitor 408. When connected to a battery 410 by switch 412, CPU 402 operates the transmitter module 404 to produce an emergency location signal from antennae 406, for example. CPU 402 may, for example, be an erasable programmable read-only memory (EPROM) or flash memory chip. Other transmitter configurations may be used without departing from the scope hereof.

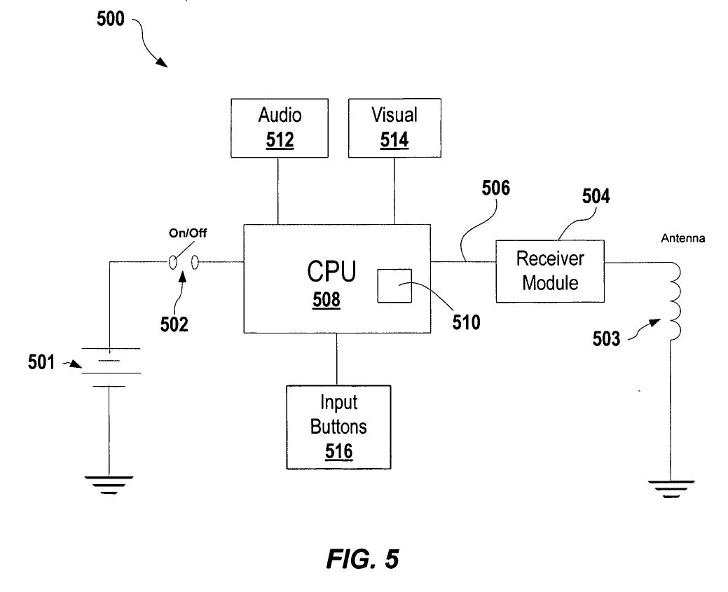

FIG. 5 shows one exemplary schematic 500 of the rescue receiver 202 of FIG. 2. Rescue receiver 202 is powered by a battery 501 when switch 502 is closed, e.g., by search button 304. Schematic 500 shows an antennae 503 that harvests signals from an emergency signal transmitter 102. The signals are sent to a receiver module 504 that converts the analog signals into a digital output 506. Digital output 506 is sent to a central processing unit (“CPU”) 508 that includes a digital decoder 510. Digital decoder 510 processes digital output 506 to determine the unique digital identification of rescue transmitter 102. CPU 508 processes digital output 506 to determine directional and distance information that is sent to one or more audio 512 and/or visual 514 outputs. CPU 508 may receive user input via input buttons 516. For example, input buttons 516 may be used to associate a person's name with their unique digital identification. Other receiver configurations may be used without departing from the scope hereof.

Rescue transceiver 300 includes features of both schematic 400 and schematic 500, where it will be appreciated that common elements, e.g., battery (410, 501), antennae (406, 503) and CPU (402, 508), may be used for both transmitting and receiving.

Transmitter 102 may be configured to operate in one of the following modes:
a) Normal mode—Transmits as specified by the international emergency signal frequency standards when manually activated.
Long life mode—Transmits a 15 second emergency signal once every minute to prolong battery life.
c) Motion sensed mode A—Transmitter 102 is activated when motion is sensed and remains activated for a predetermined time, such as at least 8 hours.
d) Motion sensed mode B—Transmitter 102 is inactive until no motion is sensed for a certain period. Following a specified period without motion, transmitter 102 activates to transmit the international emergency signal.

To operate in modes c) and d), rescue transmitter 102 also includes a motion sensor 416 for detecting motion of the transmitter (e.g., when carried in a user's pocket). Motion sensor 416 is not required for modes a) and b), and need not be fitted if modes c) and d) are not implemented, for example.

In one example of mode c) operation, rescue transmitter 102 is automatically activated when carried by a user. Mode c) is particularly suitable for users who may forget to activate rescue transmitter 102, or when rescue transmitter 102 is included with equipment or clothing of rescue personnel.

In one example of mode d) operation, rescue transmitter 102 is ‘armed’ when motion is sensed but does not activate (i.e., transmit the international emergency signal). When no motion has been detected for a certain period of time an audible, visual and/or mechanical warning is emitted allowing the user to ‘disarm’ rescue transmitter 102 if activation is undesirable. If rescue transmitter 102 is not disarmed during this warning period, rescue transmitter 102 is then activated to transmit the international emergency signal. Thus, in mode d), battery life is further enhanced since rescue transmitter 102 does not transmit until motion ceases, such as occurs when the user becomes incapacitated, and it is not manually disarmed, for example.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present devices and systems, which, as a matter of language, might be said to fall there between.

What is claimed is:

1. A transceiver for locating and identifying a victim of a manmade or natural disaster, comprising:
a transmitter for transmitting a first emergency location signal that contains a first digital identification; and
a receiver for receiving a second emergency location signal and decoding a second digital identification.

2. The system of claim 1, wherein the transmitter of the transceiver transmits at a frequency of 457 kHz.

3. The system of claim 1, wherein the receiver comprises:
circuitry for receiving the second emergency location signal;
circuitry for decoding the second digital identification within the second emergency location signal;
circuitry for providing a direction indication of the second emergency location signal relative to the receiver;
circuitry for providing an approximate distance indication from the receiver to a transmitter of the second emergency location signal; and
circuitry for displaying the decoded digital identification.

4. The system of claim 1, wherein the receiver comprises an audible output to indicate proximity of the receiver to a transmitter of the second emergency location signal.

5. The system of claim 1, wherein the transceiver comprises a display for indicating digital identification received by the receiver.

6. The system of claim 1, wherein the receiver is operable to ignore, selectively, one or more emergency location signals when the receiver receives a plurality of emergency location signals.

7. The system of claim 1, wherein the transceiver comprises a user input to input the digital identification.

8. The system of claim 1, wherein the receiver comprises visual output to indicate proximity of the transceiver to a transmitter of the second emergency location signal.

9. The system of claim 1, wherein the transmitter comprises a motion sensor, the motion sensor automatically activating the transmitter when motion is sensed.

10. The system of claim 1, wherein the transmitter comprises a motion sensor, the motion sensor automatically activating the transmitter when motion is not sensed.

11. The system of claim 1, wherein the transmitter transmits a radio signal conforming to an international emergency signal specification.

12. The system of claim 1, wherein the digital identification identifies the transmitter as a transmitter associated with a waypoint or a transmitter associated with a person.

13. The system of claim 1, wherein the receiver is operable to exclude from detection an emergency location signal selected from the group consisting of a signal transmitted by an egress transmitter and a signal transmitted by a personal transmitter.

14. The system of claim 1, wherein the receiver comprises a vibrator, and wherein the vibrator vibrates when the receiver detects an emergency location signal originating from a source directly ahead of the receiver.

15. The system of claim 1, wherein the transceiver comprises a warning mechanism for alerting a user before the transceiver automatically switches from receive mode to transmit mode, and wherein the warning mechanism is selected from an audible, visual and mechanical warning.

16. A method of performing a rescue in a hazardous environment comprising:
placing a first locator transmitter at a first waypoint near an entrance of the hazardous environment, the first locator transmitter transmitting an emergency locator signal comprising digitally encoded identification;
entering the hazardous environment to search for a victim;
using a locator receiver to identify a bearing from the locator receiver to the first locator transmitter; and
using the bearing from the locator receiver to the first locator transmitter to move towards the first waypoint.

17. The method of claim 16 further comprising:
placing a second locator transmitter at a waypoint within the hazardous environment, the second locator transmitter transmitting an emergency locator signal comprising digitally encoded identification;
using the locator receiver to identify a bearing from the locator receiver to the second locator transmitter; and
moving towards the second waypoint;
wherein the locator receiver distinguishes between the first locator transmitter and the second locator transmitter by recognizing the digitally encoded identification of the emergency locator signals.

18. The method of claim 17 wherein the locator receiver further comprises a third locator transmitter, and wherein the third locator transmitter is capable of transmitting an emergency locator signal comprising digitally encoded identification when a rescuer requires assistance.

19. A method of rescuing a person trapped by a disaster comprising:
attaching a first locator transmitter to the person;
causing the first locator transmitter to transmit an emergency locator signal comprising digitally encoded identification;
using a locator receiver to identify a bearing from the locator receiver to the first locator transmitter; and
using the bearing from the locator receiver to the first locator transmitter to locate the person.

20. The method of rescuing of claim 19 further comprising:
attaching a second locator transmitter to a second person;
causing the second locator transmitter to transmit an emergency locator signal comprising digitally encoded identification;
wherein the locator receiver receives signals from both the first and the second locator transmitters, and is capable of using the digitally encoded identification to provide a bearing selectable between a bearing from the locator receiver to the first locator transmitter and a bearing from the locator receiver to the second locator transmitter.
